(19) United States
(12) Patent Application Publication
(10) Pub. No.: US 2008/0038681 A1
(43) Pub. Date: Feb. 14, 2008

(54) Display controller for gas burners

(76) Inventor: I-Hua Huang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/502,527

(22) Filed: Aug. 11, 2006

(51) Int. Cl. F23D 5/12; G01N 19/00

(52) U.S. Cl. 431/13; 73/865.9

(57) ABSTRACT

The present invention is related to a display controller for gas burners, and connected between a metering tray for supporting a combustion gas supplying cylinder and a combustion gas electric valve unit to display the remaining time available for using combustion gas, the combustion gas supplying cylinder has the functions of automatically resetting, correcting and assure no gas leaks out.

### BACKGROUND OF THE INVENTION

1. Field of the Invention

The present invention is related to a display controller for gas burners, and especially to a display controller connected between a metering tray for supporting a combustion gas supplying cylinder and a combustion gas electric valve unit to display the remaining time available for using combustion gas, the combustion gas supplying cylinder has the functions of automatically resetting, correcting and shutting supplying of the combustion gas when fire accidentally is extinguished during use.

2. Description of the Prior Art

Earlier manufacturers provided a device under a combustion gas supplying cylinder to display the weight of the combustion gas supplying cylinder; hence a user can directly read the weight displayed, and judge by himself the remaining amount of combustion gas from the weight displayed.

The prior art displaying the remaining combustion gas by weight in the supplying cylinder lets a user know the remaining weight, however, such technique still is unable to help a common user to accurately judge how long the internal remaining amount of combustion gas can be used, and more, by virtue that the prior art device only displays by weight and does not cooperatively provides a safe controller, if the remaining time available for using combustion gas in the combustion gas supplying cylinder can display directly and particularly, and an integrated combustion gas safe controller is provided, the user can be clearly aware of the information of the combustion gas, and the user is reminded whether the combustion gas supplying cylinder shall be changed for a new one, or a spare combustion gas supplying cylinder shall be prepared for increasing the safety guard of the user.

### SUMMARY OF THE INVENTION

The display controller for gas burners of the present invention is connected between a metering tray for supporting a combustion gas supplying cylinder and a combustion gas electric valve unit, wherein the metering tray can transmit the signal meaning the weight variation of the combustion gas supplying cylinder to the display controller, a consumption rate representing the reduced weight accumulated for a period of time of the supplying cylinder can be obtained by the display controller, thereby the time duration that the remaining weight left can be used can be calculated and displayed; the metering tray is provided further with a reset switch, the display controller can automatically do zeroing when it receives a triggering signal from the reset switch by moving of the combustion gas supplying cylinder to thereby assure the accuracy of metering and timing. And after fire on a master valve of the combustion gas electric valve unit is accidentally extinguished in the middle of burning or is extinguished at a set time, gas can be automatically blocked, and a signal is transmitted to the display controller, when the display controller receives a signal indicating that all the manual valves of the combustion gas electric valve unit are shut, the master valve can then be opened to assure no gas leaks out.

The above stated metering tray includes at least a tray and a pressure detector, the pressure detector includes an elastic element and a resistance-variable piece, wherein the elastic element is provided for reacting upon the state of the pressure on the tray to deform, the resistance-variable piece is stuck to the elastic element and to generate different values of resistance in accordance with the amount of deformation of the elastic element, a signal of each value can be transmitted to the display controller.

The combustion gas electric valve unit includes the master valve and a plurality of manual valves respectively connected with the display controller, the master valve and the manual valves can transmit the signal to the display controller both in the opening or closing state.

The display controller includes at least a signal transudation unit connecting with the pressure detector in the metering tray, a signal amplifier connecting with the signal transudation unit, a microprocessor connecting with the signal amplifier and the combustion gas electric valve unit and a display connecting with the microprocessor, and further has an added electric power supplying unit connecting with the display controller.

And more, the display further includes a function push button and a displaying screen, wherein the function push button includes at least a mode-switching push button, a time-setting push button, and the displaying screen at least has a master valve action-displaying mode, a timing displaying mode, a self-cleaning displaying mode and a displaying mode of the remaining time of using combustion gas.

In comparison with the prior art, the present invention has the following effects:
1. It can directly display the remaining time available for using combustion gas, and thus is convenient for use.
2. It can automatically reset and correct to assure the accuracy of metering and timing.
3. And after fire is accidentally extinguished in the middle of burning or is extinguished at a set time, gas can be automatically blocked, when all the manual valves are shut, the combustion gas electric valve unit can be opened to assure no gas leaks out.

Besides, the present invention has other effects:

After the signal transudation unit detects the resistance value of the resistance-variable piece, a corresponding signal is released according to the variation of the resistance value for operation of the microprocessor; this can prevent the error of operation induced by change of the environmental temperature.

The present invention will be apparent in its technical measures after reading the detailed description of the preferred embodiments thereof in reference to the accompanying drawings.

### BRIEF DESCRIPTION OF THE DRAWINGS

FIG. 1 is a schematic view showing allocation of a preferred embodiment of the present invention;

FIG. 2 is a schematic side view showing that the preferred embodiment of the present invention is cooperated with a metering tray;

FIG. 3 is a perspective view of the metering tray for cooperation with of the present invention;

FIG. 4 is a block diagram showing allocation of a preferred embodiment of the present invention;

FIG. 5 is a circuit diagram of the embodiment of the present invention.

### DETAILED DESCRIPTION OF THE PREFERRED EMBODIMENT

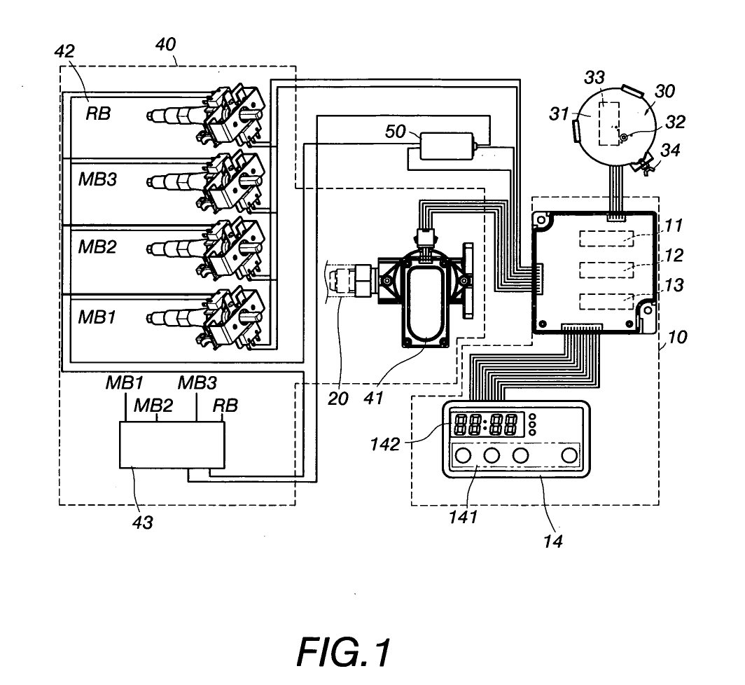

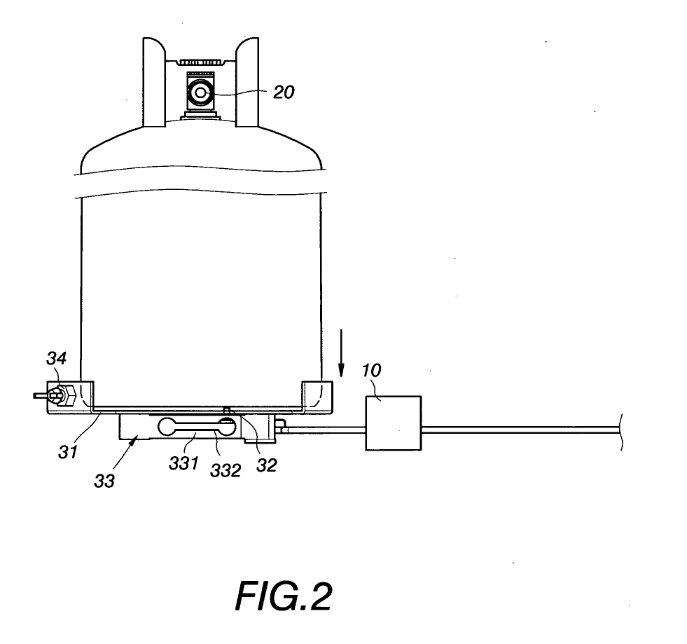

Referring to FIGS. 1 and 2, wherein a display controller 10 of the present invention is connected with a metering tray 30 on a combustion gas supplying cylinder 20 and a combustion gas electric valve unit 40, electric power for operation of the display controller 10, the metering tray 30 and the combustion gas electric valve unit 40 is provided by an electric power supply unit 50.

Wherein: the metering tray 30 includes a tray 31 that is provided thereon with a reset switch 32 contacting with the combustion gas supplying cylinder 20, the reset switch 32 generates a triggering signal when the combustion gas supplying cylinder 20 moves, the triggering signal is transmitted to the display controller 10, thereby each time when the combustion gas supplying cylinder 20 is placed once again on the top of the tray 31, the reset switch 32 will contact the bottom of the combustion gas supplying cylinder 20 to transmit the triggering signal to the display controller 10, hence the display controller 10 is zero set once again and corrected for the accuracy of weight measured to thereby assure the accuracy of metering and timing.

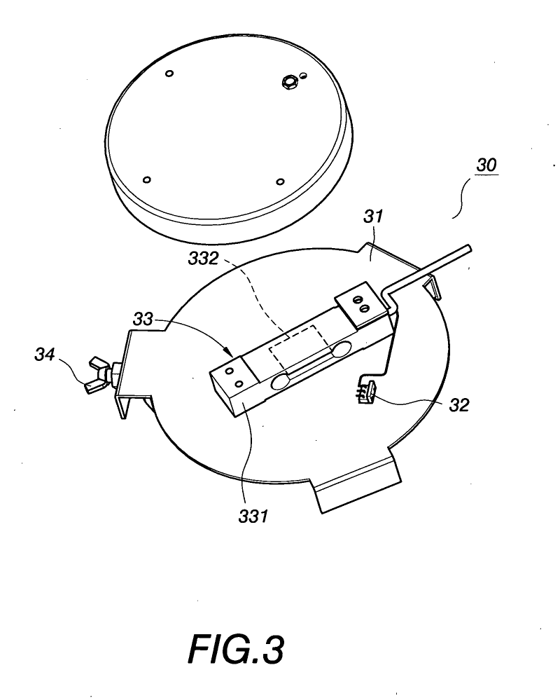

Referring to FIGS. 2 and 3, the metering tray 30 is provided further therein with a pressure detector 33, the pressure detector 33 at least includes an elastic element 331 and a resistance-variable piece 332 stuck to the elastic element 331.

Wherein the elastic element 331 is provided for reacting upon the state of the pressure on the tray 31 to deform, the resistance-variable piece 332 stuck to the elastic element 331 can generate different values of resistance in accordance with the amount of deformation of the elastic element 331, a signal of each value can be transmitted to the display controller 10. When the combustion gas supplying cylinder 20 generates variation of weight by using the gas to transmit to the display controller 10, the display controller 10 can obtain a consumption rate representing the reduced weight accumulated for a period of time of the supplying cylinder, thereby the time duration that the remaining weight left can be used in the combustion gas supplying cylinder 20 can be calculated and displayed; and the metering tray 30 is provided further with a fixing member 34 for fixing the combustion gas supplying cylinder 20.

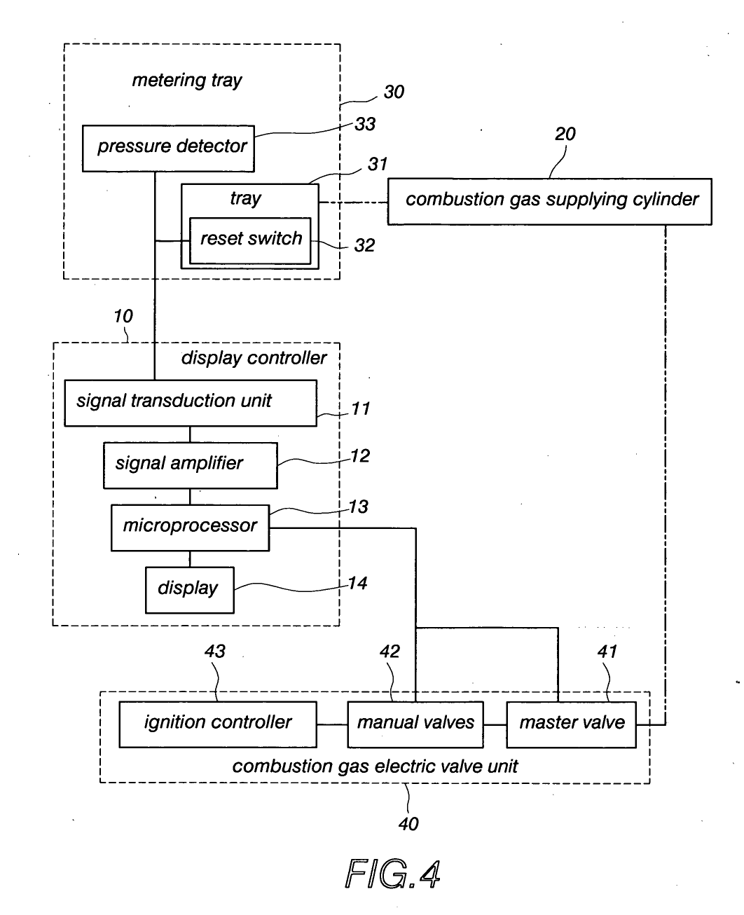

Referring to FIGS. 1 and 4, the combustion gas electric valve unit 40 mentioned above includes a master valve 41 and a plurality of manual valves 42 respectively connected with the display controller 10. When fire on the master valve 41 is accidentally extinguished in the middle of burning or is extinguished at a set time, gas can be automatically blocked, and a signal is transmitted to the display controller 10, when the display controller 10 receives a signal indicating that all the manual valves 42 are shut, the master valve 41 can then be opened for normally supplying gas and to assure no gas leaks out. Besides, the combustion gas electric valve unit 40 has an ignition controller 43 to control re-ignition of each of the manual valves 42.

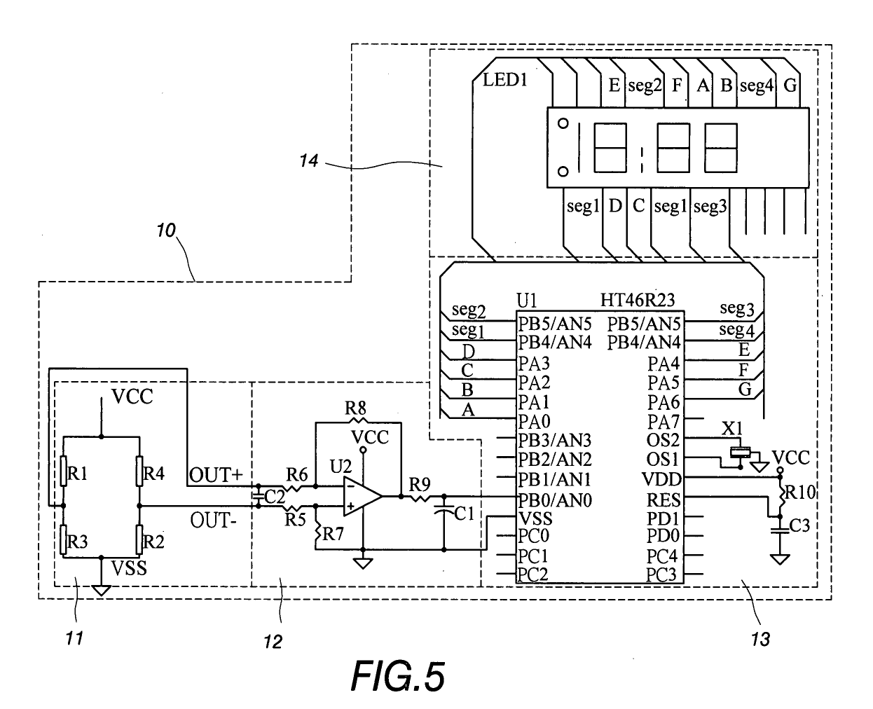

Referring to FIGS. 4 and 5, the display controller 10 includes at least a signal transduction unit 11 connecting with the metering tray 30, a signal amplifier 12 connecting with the signal transduction unit 11, a microprocessor 13 connecting with the signal amplifier 12 and the combustion gas electric valve unit 40 and a display 14.

The VCC, VSS of the signal transduction unit 11 are connected respectively with a positive and a negative electrode of an electric power supply, thus the resistance signal of the pressure detector 33 can be changed to voltage and output to the signal amplifier 12 via an OUT- and an OUT+, then the signal amplifier 12 amplifies the signal for receiving of the microprocessor 13, then the microprocessor 13 calculates the time duration available for using the remaining combustion gas, i.e., the microprocessor 13 calculates the time duration available for using the combustion gas available now from the gross weight of the combustion gas available now, and the time duration is shown in the display 14 by hours and minutes for reading of a user.

In addition to calculating the time duration available for using the remaining combustion gas, the microprocessor 13 of the display controller 10 is respectively connected with the master valve 41 and the manual valves 42 of the combustion gas electric valve unit 40, when fire on the master valve 41 connected with the display controller 10 is accidentally extinguished in the middle of burning or is extinguished at a set time, gas can be automatically blocked by shutting the master valve 41, the master valve 41 is unable to be opened again unless all the manual valves 42 have been shut.

Referring again to FIG. 1, when in practicing, the above stated display 14 can be an image display (such as a digital display screen, a liquid crystal screen), a light source display (such as a functional indicating lamp) or a sound display (such as a buzzer); thereby it can provide a user with related information through the image, light source or sound.

And more, the display 14 can further includes a function push button set 141 and a displaying screen 142, wherein the function push button set 141 includes at least a mode-switching push button, an activating and reset push button and a time-setting push button; and the displaying screen 142 can do switching among many kinds of displaying modes, for example: an action-displaying mode of the master valve 40, a timing displaying mode, a self-cleaning displaying mode and a displaying mode of the remaining time of using combustion gas etc.

The preferred embodiment shown and described is only for illustrating the present invention, and not for giving any limitation to the scope of the present invention; it will be apparent to those skilled in this art that various modifications or changes without departing from the spirit of this invention shall also fall within the scope of the appended claims.

1. A display controller for gas burners, said controller is connected between a metering tray for supporting a combustion gas supplying cylinder and a combustion gas electric valve unit, and is characterized in that:
said metering tray transmits a signal meaning weight variation of said combustion gas supplying cylinder to said display controller, a consumption rate representing reduced weight accumulated for a period of time is obtained by said display controller, thereby time duration that remaining weight left of said combustion gas supplying cylinder is to be used is calculated and displayed;
said metering tray is provided further with a reset switch contacting with said combustion gas supplying cylinder, said display controller automatically does zeroing when it receives a triggering signal from said reset switch by moving of said combustion gas supplying cylinder to thereby assure accuracy of metering and timing; and
said combustion gas electric valve unit includes said master valve and a plurality of manual valves respectively connected with said display controller, after fire on said master valve is accidentally extinguished in the middle of burning or is extinguished at a set time, gas is automatically blocked, and a signal is transmitted to said display controller, when said display controller receives a signal indicating that all said manual valves are shut, said master valve is then adapted to opening to assure no gas leaks out.

2. The display controller for gas burners as in claim 1, wherein said display controller includes a signal transudation unit connecting with said metering tray, a signal amplifier connecting with said signal transudation unit, a microprocessor connecting with said signal amplifier and said combustion gas electric valve unit and a display connecting with said microprocessor.

3. The display controller for gas burners as in claim 2, wherein said display controller further has an electric power supplying unit connecting with said microprocessor.

4. The display controller for gas burners as in claim 1, wherein said metering tray is provided further with a tray and a pressure detector, said pressure detector is composed of an elastic element and a resistance-variable piece stuck to said elastic element.

5. The display controller for gas burners as in claim 2, wherein said display further includes a function push button and a displaying screen.

6. The display controller for gas burners as in claim 5, wherein said function push button includes at least a mode- switching push button, an activating and reset push button and a time-setting push button.

7. The display controller for gas burners as in claim 5, wherein said displaying screen at least has a master valve action-displaying mode, a timing displaying mode, a self-cleaning displaying mode and a displaying mode of remaining time of using combustion gas.

8. The display controller for gas burners as in claim 1, wherein said combustion gas electric valve unit has an ignition controller connecting to each of said manual valves.
